(19) United States
(12) Patent Application Publication
(10) Pub. No.: US 2026/0049832 A1
(43) Pub. Date: Feb. 19, 2026

(54) METHOD AND DEVICE FOR ESTIMATING TRAFFIC CONGESTION BASED ON ROUTE DEMAND

(71) Applicants: Hyundai Motor Company, Seoul (KR); Kia Corporation, Seoul (KR)

(72) Inventor: Nam Hyuk Kim, Hwaseong-si (KR)

(21) Appl. No.: 19/292,638

(22) Filed: Aug. 6, 2025

(30) Foreign Application Priority Data
Aug. 13, 2024 (KR) 10-2024-0108355

(51) Int. Cl. G01C 21/36; G08G 1/01

(52) U.S. Cl. CPC G01C 21/3679; G08G 1/0112; G08G 1/0125

(57) ABSTRACT

A method and device for estimating congestion based on route demand utilize an electronic apparatus having a processor and a memory in order to determine an optimal route of a user of a vehicle. The method includes: acquiring demand data based on vehicles that are expected to be traveling to a point of interest (POI) related to a user request; estimating, by an estimation model, congestion of the POI based on the demand data; and providing the congestion of the POI to an electronic device of the user, so that the user can optimally reach the POI as a destination in the vehicle. For example, the vehicles may be expected to be traveling in real time along at least portion of routes to the POI.

### CROSS-REFERENCE TO RELATED APPLICATION

This application claims under 35 U.S.C. § 119(a) the benefit of Korean Patent Application No. 10-2024-0108355, filed on Aug. 13, 2024, the entire contents of which are incorporated herein by reference.

### BACKGROUND

### 1. Technical Field

The present disclosure relates to a method and device for estimating traffic congestion based on route demand, more particularly, to the congestion estimation method and device based on route demand that provides a real-time congestion status of a point of interest (POI) in accordance with a user in a vehicle who is searching for the POI.

### 2. Description of the Related Art

An electronic device may have a navigation function for providing a route to a destination desired by a user on a map. Although the electronic device may be a portable device, such as a smartphone, the electronic device is not limited thereto and may be a product that is manufactured in various forms having similar software functions to portable devices. The product may incorporated into a form of transportation, for example, a vehicle.

When a user requests a route to a destination, the navigation function may search for a point of interest (POI) directly related to the destination and also a POI deemed suitable with regard to a user's intention as inferred from the destination, and provide routes to found or obtained POIs. The obtained POIs are meant to be based on the user's intention such that the user can check information of various POIs. However, existing navigation functions mainly propose routes only and do not provide a congestion status of a POI. When a user selects a found POI in consideration of the purpose of visiting the POI, a time to use the POI, and the like, a congestion status may be important data for selecting the user's POI. Also, a congestion status may be meaningful for recommending a POI. Further, the congestion status of a POI that is provided irrespective of a user's expected arrival time at a POI and the user's distance to the POI may be meaningless or confusing to the user.

### SUMMARY

The present disclosure provides a congestion estimation method and device based on route demand for improving the accuracy of congestion information by providing a real-time congestion status of a point of interest (POI) in accordance with a situation of a user (e.g., in a vehicle) who is searching for the POI.

Technical objects to be achieved by the present disclosure are not limited to that described above, and other technical objects that have not been described will be clearly understood by those skilled in the technical field to which the present disclosure pertains from the following description.

According to the present disclosure, a method of estimating congestion based on route demand includes: providing an electronic apparatus including at least a memory and a processor; acquiring, by the processor, demand data based on vehicles that are expected to be traveling to a point of interest (POI) related to a user request; estimating, by a processor utilizing an estimation model stored in the memory, congestion of the POI based on the demand data; and providing the congestion of the POI to an electronic device of a user.

For example, the vehicles may be expected to be traveling in real time along at least portion of routes to the POI.

According to an aspect of the present disclosure, there is provided a method of estimating congestion based on route demand. The method may include: acquiring demand data based on vehicles that are expected to be traveling in real time along routes detected for a point of interest (POI) related to a user request; estimating, by an estimation model, congestion of the POI based on the demand data; and providing the congestion of the POI to an electronic device of a user.

According to the embodiment of the present disclosure in the method, the vehicles that are expected to be traveling along the detected routes may be vehicles that travel along at least portion of the routes as other users of the vehicles request a route to the POI.

According to the embodiment of the present disclosure in the method, the demand data may be generated based on a number of vehicles that are expected to be traveling to a road segment on the routes for entering the POI at a specified time determined based on the user's expected arrival time at the POI.

According to the embodiment of the present disclosure in the method, the demand data may be generated based on a plurality of vehicles, the road segment on the routes for entering the POI may be a road link that is adjacent to the POI and connected to the POI, and the routes detected in at least portion of the plurality of other vehicles may include commonly the road link connected to the POI.

According to the embodiment of the present disclosure in the method, the congestion may be generated based on expected stay time of the vehicles at the POI.

According to the embodiment of the present disclosure in the method, the estimation model may be implemented as a deep learning model, the estimation model may be constructed through training using actual congestion based on actual stay time of vehicles at the POI and training demand data corresponding to the actual congestion, and the training demand data is acquired based on vehicles that search for a route to the POI and travel along at least portion of the route.

According to the embodiment of the present disclosure in the method, the actual stay time may be determined based on times when arrival of the vehicle at the POI is confirmed and times when departure of the vehicle from the POI is confirmed.

According to the embodiment of the present disclosure in the method, the actual congestion may be generated based on an average of actual stay time accumulated for each of time periods at the POI, and the average of the actual stay time may be calculated as an average of the accumulated actual stay time corresponding to the time periods.

According to the embodiment of the present disclosure in the method, the providing of the congestion of the POI further may comprise providing other POIs and congestion of the other POIs together with the POI, the other POIs being determined to be similar to the POI based on additional information, or recommending at least one of a plurality of POIs based on the congestion and the additional information.

According to the embodiment of the present disclosure in the method, the additional information may include at least one of user information including the POI in accordance with the user request and the user's allowed stay time, map information including locations of other POIs within a certain range from the POI, or rating information having ratings for use of POIs.

According to the present disclosure, an electronic apparatus for estimating congestion based on route demand includes: a communication unit configured to transmit and receive data to and from an external device; a memory configured to store at least one instruction; and a processor configured to execute the at least one instruction stored in the memory, wherein the processor is configured to: acquire demand data based on vehicles that are expected to be traveling to a point of interest (POI) related to a user request, estimate congestion of the POI based on the demand data using an estimation model stored in the memory, and provide the congestion of the POI to an electronic device of a user.

For example, the vehicles may be expected to be traveling in real time along at least portion of routes to the POI.

According to another aspect of the present disclosure, there is provided an electronic apparatus for estimating congestion based on route demand. The electronic apparatus comprising: a communication unit configured to transmit and receive data to and from an external device; a memory configured to store at least one instruction; and a processor configured to execute the at least one instruction stored in the memory. The processor is configured to acquire demand data based on vehicles that are expected to be traveling in real time along routes detected for a point of interest (POI) related to a user request, estimate congestion of the POI based on the demand data using an estimation model, and provide the congestion of the POI to an electronic device of a user.

According to the present disclosure, a non-transitory computer readable medium containing program instructions executed by a processor includes: program instructions that acquire demand data based on vehicles that are expected to be traveling to a point of interest (POI) related to a user request; program instructions that utilize an estimation model to estimate congestion of the POI based on the demand data; and program instructions that provide the congestion of the POI to an electronic device of a user.

According to the present disclosure, it is possible to provide a congestion estimation method and device based on route demand that improve the accuracy of congestion information by providing a real-time congestion status of a POI in accordance with a situation of a user who is searching for the POI.

In addition, it is possible to increase the reliability of various application functions that are implemented based on accurate congestion information and include recommendation of POIs.

Effects that can be obtained from the present disclosure are not limited to those described above, and other effects that have not been described will be clearly understood by those skilled in the technical field to which the present disclosure pertains from the following description.

### BRIEF DESCRIPTION OF THE DRAWINGS

FIG. 1 is a diagram illustrating a vehicle communicating with other devices to transmit and receive data.

FIG. 2 is a diagram of modules constituting a vehicle.

FIG. 3 is a diagram of modules constituting an electronic apparatus according to an embodiment of the present disclosure.

FIG. 4 is a diagram schematically showing a congestion estimation model.

FIG. 5 is a diagram illustrating a structure of a congestion estimation model.

FIG. 6 is a diagram illustrating a heat map used for demand data.

FIG. 7 is a diagram illustrating a stay time used for generating congestion.

FIG. 8 is a flowchart of a congestion estimation method based on route demand according to another embodiment of the present disclosure.

### DETAILED DESCRIPTION OF EXEMPLARY EMBODIMENTS

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g. fuels derived from resources other than petroleum). As referred to herein, a hybrid vehicle is a vehicle that has two or more sources of power, for example both gasoline-powered and electric-powered vehicles.

The terminology used herein is for the purpose of describing particular embodiments only and is not intended to be limiting of the present disclosure. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items. Throughout the specification, unless explicitly described to the contrary, the word “comprise” and variations such as “comprises” or “comprising” will be understood to imply the inclusion of stated elements but not the exclusion of any other elements. In addition, the terms “unit”, “-er”, “-or”, and “module” described in the specification mean units for processing at least one function and operation, and can be implemented by hardware components or software components and combinations thereof.

Further, the control logic of the present disclosure may be embodied as non-transitory computer readable media on a computer readable medium containing executable program instructions executed by a processor, controller or the like. Examples of computer readable media include, but are not limited to, ROM, RAM, compact disc (CD)-ROMs, magnetic tapes, floppy disks, flash drives, smart cards and optical data storage devices. The computer readable medium can also be distributed in network coupled computer systems so that the computer readable media is stored and executed in a distributed fashion, e.g., by a telematics server or a Controller Area Network (CAN).

Hereinafter, exemplary embodiments of the present disclosure will be described in detail with reference to the accompanying drawings so that those skilled in the art may easily implement the present disclosure. However, the present disclosure may be implemented in various different ways, and is not limited to the embodiments described therein.

In describing exemplary embodiments of the present disclosure, well-known functions or constructions will not be described in detail since they may unnecessarily obscure the understanding of the present disclosure. The same constituent elements in the drawings are denoted by the same reference numerals, and a repeated description of the same elements will be omitted.

In the present disclosure, when an element is simply referred to as being “connected to”, “coupled to” or “linked to” another element, this may mean that an element is “directly connected to”, “directly coupled to” or “directly linked to” another element or is connected to, coupled to or linked to another element with the other element intervening therebetween. In addition, when an element “includes” or “has” another element, this means that one element may further include another element without excluding another component unless specifically stated otherwise.

In the present disclosure, the terms first, second, etc. are only used to distinguish one element from another and do not limit the order or the degree of importance between the elements unless specifically mentioned. Accordingly, a first element in an embodiment could be termed a second element in another embodiment, and, similarly, a second element in an embodiment could be termed a first element in another embodiment, without departing from the scope of the present disclosure.

In the present disclosure, elements that are distinguished from each other are for clearly describing each feature, and do not necessarily mean that the elements are separated. That is, a plurality of elements may be integrated in one hardware or software unit, or one element may be distributed and formed in a plurality of hardware or software units. Therefore, even if not mentioned otherwise, such integrated or distributed embodiments are included in the scope of the present disclosure.

In the present disclosure, elements described in various embodiments do not necessarily mean essential elements, and some of them may be optional elements. Therefore, an embodiment composed of a subset of elements described in an embodiment is also included in the scope of the present disclosure. In addition, embodiments including other elements in addition to the elements described in the various embodiments are also included in the scope of the present disclosure.

The advantages and features of the present disclosure and the way of attaining them will become apparent with reference to embodiments described below in detail in conjunction with the accompanying drawings. Embodiments, however, may be embodied in many different forms and should not be constructed as being limited to example embodiments set forth herein. Rather, these embodiments are provided so that this disclosure will be complete and will fully convey the scope of the disclosure to those skilled in the art.

In the present disclosure, each of phrases such as “A or B”, “at least one of A and B”, “at least one of A or B”, “A, B or C”, “at least one of A, B and C”, “at Each of the phrases such as “at least one of A, B or C” and “at least one of A, B, C or combination thereof” may include any one or all possible combinations of the items listed together in the corresponding one of the phrases.

Hereinafter, embodiments of the present disclosure will be described with reference to the accompanying drawings.

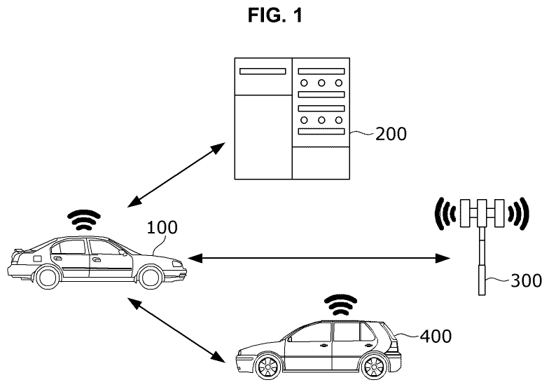

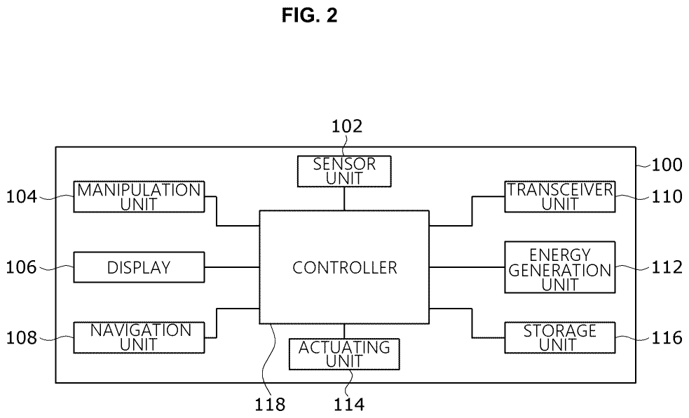

Referring to FIGS. 1 and 2, an electronic device and a vehicle for estimating congestion based on demand derived from route navigation will be described. FIG. 1 is a diagram illustrating a vehicle communicating with other devices to transmit and receive data. FIG. 2 is a diagram of modules constituting a vehicle.

In the present disclosure, an electronic device is described as an example that processes route requests and usage requests for point of interest received from the vehicle 100. The electronic device may be, for instance, a server 200 that implements a navigation function to process requests from the vehicle 100 while communicating with the vehicle 100. Unlike the example described above, the electronic device may also communicate with other types of electronic devices besides the vehicle, and an electronic device such as a mobile terminal (e.g., a smartphone) may transmit route requests and usage requests for points of interest to the electronic device 200. The electronic device can process the requests from the mobile terminal. Accordingly, the matters described below are primarily explained with a focus on the processing of usage requests between the vehicle 100 and the electronic device 200 (server), but they can be substantially applied to a mobile terminal in the same manner.

Referring to FIG. 1, the vehicle 100 may be driven based on electric energy or fossil energy. In the case of electric energy, the vehicle 100 may adopt a pure battery-based vehicle driven solely by a high-voltage battery or a gas-based fuel cell as an energy source. The fuel cell may utilize various types of gases capable of generating electric energy, and the gas may be filled in the vehicle 100 in a liquefied state. For instance, the gas may be hydrogen, but various other gases may also be applicable. In the case of fossil energy, the vehicle 100 may be driven based on fuels such as gasoline, diesel, or liquefied gas, and it may be equipped with an internal combustion engine that drives an actuator 114 by burning the fuel. As another example, the vehicle 100 may be a hybrid type vehicle selectively utilizing the energy of a fossil fuel-based internal combustion engine and an electric battery to drive the actuating unit 114.

The vehicle 100 may refer to a movable device. The vehicle 100 may be a ground vehicle, such as a typical passenger or commercial vehicle, or a purpose-built vehicle (PBV) for specific purposes. The vehicle 100 may be a four-wheeled vehicle, such as a passenger car, SUV, or small truck, or a vehicle with more than four wheels, such as a bus, large truck, container carrier, or heavy equipment. The vehicle 100 may also be a robot in the broad sense of a movable means, and the robot may move using wheels, tracks, or other mobility modules.

The vehicle 100 may be controlled and driven autonomously, and autonomous driving may be implemented as semi-autonomous driving or fully autonomous driving.

Meanwhile, the vehicle 100 may perform communication with other devices 200, 300, or other vehicles 400. The other devices may include, for example, a server 200 supporting various control state management and driving of the vehicle 100, an Intelligent Transportation System (ITS) device 300 for receiving information from ITS, and various types of user devices. The server 200 may be an external device operated by a vehicle manufacturer or prepared to provide autonomous driving services and may transmit or receive connected data necessary for autonomous driving to or from the vehicle 100. The server 200 may transmit various information and software modules used for the control of the vehicle 100 in response to requests and data transmitted from the vehicle 100 and user devices to support autonomous driving and various services of the vehicle 100.

The server 200 may process a route request for a point of interest (POI) made by the vehicle 100 and also estimate and provide congestion of the POI to the vehicle 100. Here, the POI may be a place specified by a user inputting a specific name to the navigation unit 108 or a place that is output in association with a rough term that is input to the navigation unit 108. The specific name is the unique name of a spot or a specific position and may be, for example, AA restaurant, BB resort, CC intersection, DD avenue, or the like. A rough term may be, for example, a service term, a category, or the like that a user wants to use, and as an example, a restaurant, a café, an attraction in a particular area, or the like may be input. When the user searches for a POI using a rough term, the user may input a service term or a category to be used at a current location or another location to the navigation unit 108.

To estimate congestion, the server 200 may manage demand data of other vehicles related to the POI requested by the user. As provided herein, “demand data” refers to data of other vehicles expected to travel to the POI at a point of time coinciding with a request of the user. The demand data may be constructed based on at least one vehicle other than an ego-vehicle 100 (e.g., a self driving vehicle) of the user. The demand data may be generated based on another vehicle that travels along at least a part of a route to the POI requested by a user of the vehicle. The demand data may be generated by, for example, the server 200 or may be generated by, as another example, an external device and transmitted to the server 200. The server 200 or the external device may generate demand data by receiving, in real time, status data including planned routes of navigation, destinations, estimated travel times, departure/arrival, whether it is started, and the like from a plurality of vehicles. Demand data will be described in detail below.

The ITS device 300, for instance, may be a Road Side Unit (RSU). The ITS device 300 may exchange vehicle perception data, driving control and state data, environmental data around the vehicle, and map data with the vehicle 100 through Vehicle-to-Infrastructure (V2I) communication to assist the user's driving or support autonomous driving of the vehicle 100. The vehicle 100 may support manual or autonomous driving by exchanging the aforementioned data with other vehicles 400 through Vehicle-to-Vehicle (V2V) communication.

The vehicle 100 may perform communication with other vehicles or devices based on cellular communication, Wireless Access in Vehicular Environment (WAVE) communication, Dedicated Short Range Communication (DSRC), or other communication methods. For instance, the vehicle 100 may use communication networks such as LTE or 5G, WiFi networks, or WAVE networks for communication with the server 200, ITS device 300, and other vehicles 400. In another example, DSRC used in the vehicle 100 may be utilized for inter-vehicle communication. The communication methods among the vehicle 100, the server 200, the ITS device 300, other vehicles 400, and user devices are not limited to the above-described embodiments.

FIG. 2 is a diagram of modules constituting a vehicle.

The vehicle 100 may include a sensor unit 102, a manipulation unit 104, a display 106, a navigation unit 108 and a transceiver unit 110.

The sensor unit 102 may be equipped with various types of detectors to sense various states and situations occurring in the external environment, internal system, user operations, and passenger space of the vehicle 100. The sensor unit 102 may include external-facing camera, LIDAR sensor, radar sensor, and the like to recognize dynamic and static objects existing outside the vehicle 100. The sensor unit 102 may include positioning sensor, wheel sensor, and attitude sensor to confirm its position, speed, and driving posture. A detection module for identifying various situations not listed above may be additionally included in the sensor unit 102.

The manipulation unit 104 may be configured as a module for user control for driving. For instance, the manipulation unit 104 may include a steering wheel for manual driving, an automatic or manual transmission actuator, an accelerator pedal, a brake pedal, a gearbox, etc. The manipulation unit 104 may further include an interface for the use/deactivation of the autonomous driving mode requested by the user and the selection of detailed function to utilize the autonomous driving function.

The display 106 may function as a user interface. The display 106 may display the operation state, control state, route/traffic information, remaining energy information, and contents requested by the driver of the vehicle 100 as controlled by a controller (and/or processor) 118 of the vehicle 100. The display 106 may also receive driver's requests instructing the controller 118 by being configured as a touch screen detecting driver input.

The navigation unit 108 may receive the user's route request for the destination to transmit the route request to the server 200 and may receive route information and congestion of the POI from the server 200 to provide the received information. The navigation unit 108 may be executed on the display 106 or implemented in a separate device installed in the vehicle 100. The separate device may be, for example, a module uniquely installed in the vehicle 100 or the user's electronic device that is connected to the vehicle 100 with or without a wire. The user's electronic device may be controlled to access the vehicle 100 and show the route request, the route information, and the congestion information in an output interface such as the display 106.

The present disclosure primarily describes modules related to the present embodiment in FIG. 2, but the vehicle 100 may further include a load device in addition to the navigation unit 108. The load device may be mounted on the vehicle 100 and be a kind of electric device for non-driving use, excluding the driving power system such as the wheel driver. The load device may be an auxiliary device supplied with power from the energy generation unit 112, such as an air conditioning system, lighting system, seat system, and various devices installed in the vehicle 100.

The transceiver unit 110 may support mutual communication with the server 200, ITS device 300, and surrounding vehicles 400. The transceiver unit 110 may include modules handling cellular communication, WAVE, DSRC communication, etc. The transceiver unit 1101 may also support communication with electronic devices carried by passengers inside the vehicle 100.

The vehicle 100 may also include the energy generation unit 112 and the actuating unit 114.

The energy generation unit 112 may generate and supply power and electricity used in the driving power system, such as the actuating unit 118, and the non-driving power system. The non-driving power system may include, for example, the sensor unit 102, manipulation unit 104, display 106, load device, transceiver unit 110, and the like. When the vehicle 100 is driven based on electric energy, the energy generation unit 112 may be configured as an electric battery charged from an external source or a combination of an electric battery and a fuel cell charging the battery. When the vehicle 100 is driven based on fossil energy, the energy generation unit 112 may be configured as an internal combustion engine. Additionally, when the vehicle 100 is of a hybrid type, the energy generation unit 112 may be provided as a combination of an internal combustion engine and an electric battery.

The actuating unit 114 may include at least one module implementing driving operations and may perform at least one of longitudinal control, such as acceleration and deceleration, or lateral control, such as steering, based on user requests from the manipulation unit 104. To this end, the actuating unit (114) may include a plurality of wheels, a driving force generation module for generating driving force and applying it to the wheels or transmitting the driving force, a braking module for decelerating the driving of the wheels, and a steering module for realizing lateral control of the wheels, among others. When the vehicle 100 is driven based on electric energy, the driving force generation module may include a motor assembly, and the braking module may further include a regenerative braking function.

Also, the vehicle 100 may include a storage unit 116 and the controller 118.

The storage unit 116 may store applications and various data for controlling the vehicle 100 and load an application or read or record data at a request of the controller 118. In the present disclosure, the storage unit 116 may have a software module for processing route guidance, for example, a navigation application.

The controller 118 may perform overall control of the vehicle 100. The controller 118 may be configured to execute an application stored in the storage unit 116 and instructions. The controller 118 may execute the navigation application to process the user's request. Specifically, the controller 118 may receive the route request for the POI input by the user to transmit the route request to the server 200 and may provide a response of the server 200 processing the request to the user.

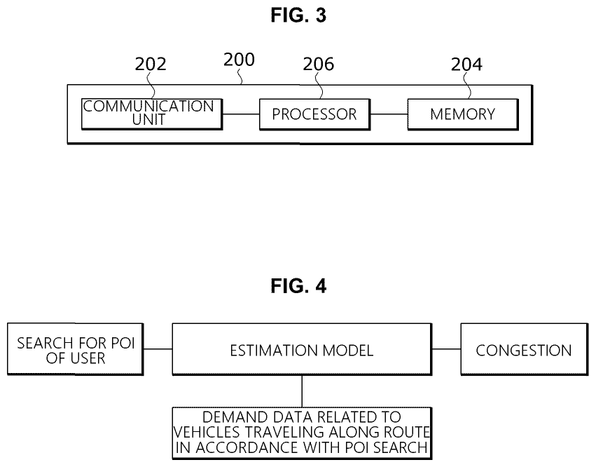

FIG. 3 is a diagram of modules constituting an electronic apparatus according to an embodiment of the present disclosure. In the present disclosure, an electronic apparatus that executes a POI use request employing waiting time estimation may be exemplified as the server 200 communicating with the vehicle 100.

As described above, the server 200 may perform a navigation function of providing various service functions based on a route to a POI and congestion in response to route guidance of the vehicle 100 and requests. The server 200 may include a communication unit 202, a memory 204, and a processor 206.

The communication unit 202 transmits and receives data to and from an external device. In the present disclosure, the communication unit 202 supports intercommunication with the vehicle 100 and may exchange data with the vehicle 100.

The memory 204 may store applications and various data for running the server 200 and load an application or read or record data at a request of the processor 206. In the present disclosure, the memory 204 may have a software module, for example, a navigation application, for processing a request, for example, a request related to route guidance and congestion providing, received from the vehicle 100. The memory 204 may manage map information for processing a route request, demand data for congestion estimation, spot information related to POIs, and additional information for listing and recommending a plurality of POIs.

The spot information may have at least one of, for example, types of spots, operational information of spots, items provided at spots, sizes of spots, or customer accommodation capacities of spots. The types of spots may be unique functions or service types of spots. For example, the types may be classified by functions, services, or the like of restaurants, tourist sites, cafés, streets, and convenience/amusement facilities. The operational information of spots may include, for example, opening hours of spots, the possibilities of booking, the presence or absence of a parking lot, and the like. The items provided at spots may be a detailed menu of services. For example, the items may include the menus of restaurants/cafés or various menus offered by convenience facilities or amusement facilities. The sizes of spots may include, for example, the sizes of the corresponding facilities, the turnover rates of customers using the spots, and the like. The customer accommodation capacities of spots may include, for example, the maximum numbers of people who can visit the spots, the numbers of seats, the maximum numbers of people who can wait in line, and the like.

The additional information may include user information, map information, and rating information. The user information may include, for example, spot information related to POIs in accordance with user requests, allowed stay time checked from users' stay time in the past, schedule data about users' use of POIs, and the like. As additional information, the map information may include the locations of other POIs within a certain range from the POIs related to the user requests. The rating information may have a plurality of users' ratings for various spots including POIs. The rating information may be received from a management server of a spot via, for example, the users' portable terminals, a social medium, or a web.

The processor 206 may perform overall control of the server 200. The server 200 may be configured to execute applications and instructions stored in the memory 204. The processor 206 may execute the navigation application to process a user's request transmitted from the vehicle 100 and respond to the request. Specifically, the processor 206 may perform a process of acquiring demand data based on vehicles that are estimated to be traveling in real time along routes detected in relation to a POI related to a user request. The processor 206 may perform a process of estimating congestion of the POI based on the demand data using an estimation model and providing the congestion of the POI to the user's electronic device.

In the present disclosure, the processor 206 is illustrated as being configured as a single processing module. As another example, the processor 206 may be distributed among a plurality of processing modules, and the above process may be performed by the distributed processing modules.

Meanwhile, the estimation model is embedded in the memory 204 and can be loaded and executed by the processor 206 at a user request. The processor 206 may transmit congestion output by the estimation model and various additional data based on the congestion to the vehicle 100. As shown in FIG. 4, the estimation model may be a rule-based mathematical model or a machine-learning-based model. FIG. 4 is a diagram schematically showing a congestion estimation model.

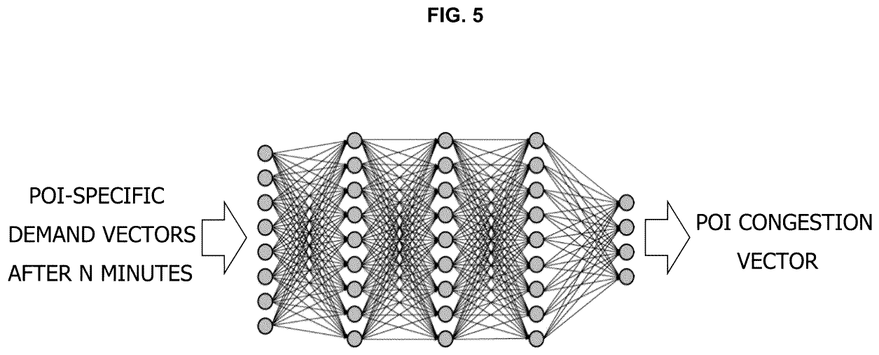

When the estimation model is a machine-learning-based model, congestion of a POI corresponding to output data may be inferred in real time based on demand data of other vehicles heading toward the POI related to a request of the ego-vehicle 100 as illustrated in FIG. 5. FIG. 5 is a diagram illustrating a structure of a congestion estimation model. As illustrated in FIG. 5, the congestion estimation model may be implemented as a neural network model which is a deep learning model. As shown in FIG. 5, the estimation model is a network that implements classification based on a fully connected layer, and for example, a congestion level may be provided as congestion information by the network. The estimation model is not limited to a neural network model and may be constructed in various deep learning network structures.

Specifically, with regard to demand data, data of other vehicles related to the user's found POI requested from the estimation model is selected, and the selected data may be utilized as input data of the estimation model. When a route guide to a POI derived from a request of the ego-vehicle 100 is requested, the demand data may be data related to other vehicles that are traveling along at least a part of a route for which guidance is provided upon the request of the ego-vehicle 100. The demand data may be related to other vehicles of which both route requesting via navigations and traveling along the routes are detected. The other vehicles are vehicles that are expected to move to the POI along guidance routes but may include vehicles that do not ultimately move to the POI and thus use parts of guidance routes. Other vehicles that use parts of routes are considered potential users of the POI and may be employed as demand data.

Also, the demand data may be generated based on operations of a plurality of other vehicles and may have, for example, data including the number of other vehicles that are expected to travel to the POI. The demand data may be data including the number of vehicles that are expected to be traveling to a road segment on a route for entering the POI at a specified time determined based on the user's expected arrival time at the POI.

The specified time may be set, for example, within a certain range from the expected arrival time. For example, the specified time may be set in a range from S hours before the expected arrival time to N hours after the expected arrival time, where S and N may be specified by an administrator of the server 200. The time conditions of other vehicles selected as demand data are related to the expected arrival time of the ego-vehicle 100 because the plurality of other vehicles arrive at the POI at different times due to different routes and different travel times based on different departure points. Since the user of the ego-vehicle 100 is interested in the congestion at the POI at the expected arrival time, the congestion at times much earlier or later than the expected arrival time may be meaningless. For this reason, vehicles that are expected to be traveling at the specified time may be targeted for demand data collection.

Also, routes detected in at least some of a plurality of other vehicles may include a road link connected to the POI in common. Specifically, when a plurality of other vehicles have different departure points or different guidance routes as described above, the plurality of other vehicles may include a road link of some of various routes to the POI. When the plurality of other vehicles have the same departure point and guidance routes, it is evident that each vehicle may have the same route to the POI.

In addition, a road segment on a route may be a road link that is adjacent to the POI and connected to the POI. Here, the road link may be a road directly connected to the POI or the POI that is the last stop of a route. When the POI does not have a parking lot, a vehicle may be parked in a parking facility near the POI. Accordingly, with regard to route conditions of other vehicles employed as demand data, the road segment may include a road for approaching the POI. When the POI has no parking lot, the road segment may include a road link adjacent to a neighboring parking facility.

The congestion may be generated based on expected stay time of the vehicles.

Accordingly, the estimation model may be trained using input data and output data which are used for congestion inference in the vehicle 100, as training data.

A congestion estimation network employing a neural network may be constructed through training using actual congestion based on an actual stay time of the vehicle 100 at the POI and training demand data corresponding to the actual congestion. The actual congestion and the training demand data may be provided for each of a plurality of POIs. The estimation model may be constructed such that an input layer and an output layer corresponding to demand data and congestion may have as many nodes as POIs. Accordingly, when the user searches for a POI, demand data of a plurality of POIs upon the user request is collected in real time, and also the congestion of the plurality of POIs resulting from the search is output from a single model, which can increase the efficiency and precision of the model.

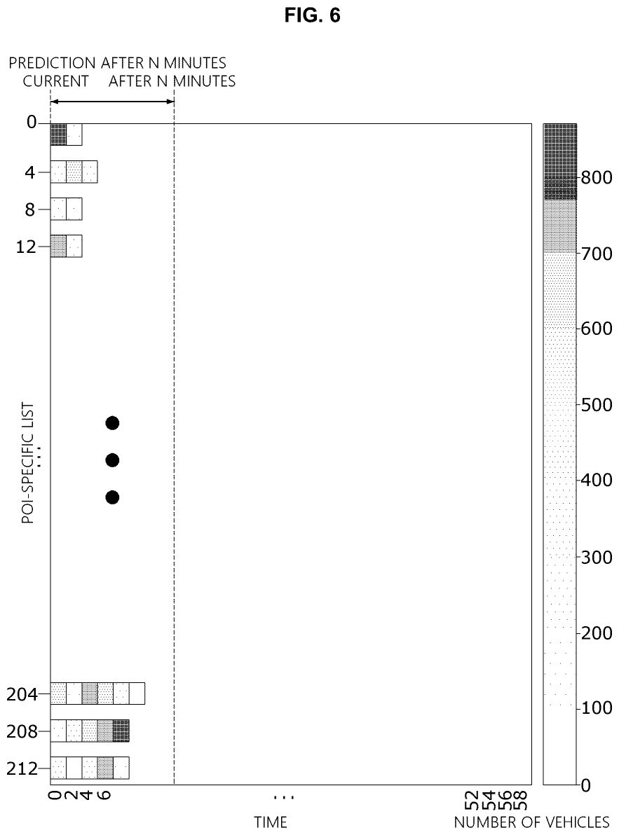

As illustrated in FIGS. 5 and 6, training demand data may be acquired based on the number of vehicles that search for a route to the POI and travel along at least portion of the route. FIG. 6 is a diagram illustrating a heat map used for demand data. FIG. 6 illustrates demand data used for training or inference of the estimation model, and demand data used for training may be referred to as training demand data. Training demand data is generated using existing traffic data which is collected from each POI, and traffic data may be data representing operations of vehicles traveling along routes to a POI.

Training demand data may include the number of vehicles distinguished for each POI as shown in FIG. 6. Also, training demand data may be generated by assuming that a time corresponding to a time point when the ego-vehicle requests the POI is the start time on the horizontal axis (or time axis). In the same manner as inference of congestion estimation, training demand data may employ vehicles that are expected to be traveling along at least a part of a route for entering a POI at a specified time determined based on the ego-vehicle's expected arrival time to the POI, for example, a time N minutes after the start time. Also, vehicles corresponding to the specified time in the demand data of FIG. 6 may be estimated to be in a road link that is adjacent to a POI and connected to the POI. At least some of a plurality of vehicles corresponding to the specific time may include the road link connected to the POI in common as a detected route. The demand data aggregated in FIG. 5 may be converted into a demand vector to be input to a neural network model as illustrated in FIG. 6. For example, a demand vector D_{N} of M POIs after N minutes may be expressed as

$${D}_{N} = [ \begin{matrix}{d}_{N}^{0} \\ ⋮ \\ {d}_{N}^{M}\end{matrix} ] .$$

Meanwhile, actual congestion may represent, for example, an actual congestion status of each POI. An actual stay time used for generating actual congestion may be determined, for example, based on a time when a vehicle's arrival at a POI is confirmed and a time when the vehicle's departure from the POI is confirmed. Specifically, an actual stay time STₘ of a vehicle at a POI m may be calculated in accordance with Expression 1, where

$${t}_{n + 1}^{first}$$

may be an end time of previous travel and

$${t}_{n}^{last}$$

may be a start time of next travel. The end time may be identified when the vehicle's end operation, for example, turning off the engine, being stopped for a certain time or more, or the like, at the POI is detected by the server 200. The start time may be identified when the vehicle's start operation, for example, turning on the engine, traveling for a certain time or more after the engine is turned on, or the like, at the POI is detected by the server 200.

$${ST}_{m} = {t}_{n + 1}^{first} - {t}_{n}^{last} \qquad [ Expression 1 ]$$

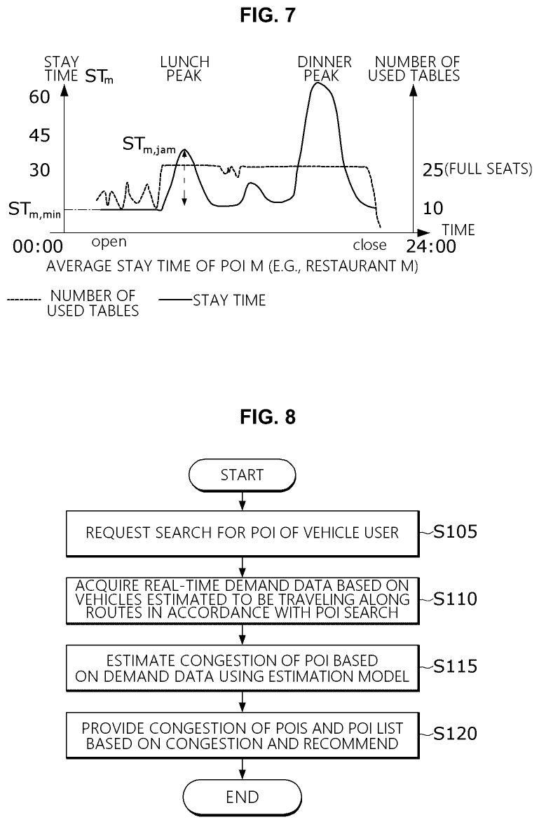

As shown in FIG. 7, an actual stay time may be recorded for each vehicle during every time period at a POI. FIG. 7 is a diagram illustrating a stay time used for generating congestion. Taking FIG. 7 as an example, the actual stay time may be calculated as an average of stay time of vehicles at a POI m. Also, to check an actual stay time during each time period, an actual stay time may be calculated as an average of accumulated actual stay time corresponding to time periods. In addition to this, the actual stay time may be generated based on time-specific stay time collected during a certain time period, and the average for the actual stay time may be calculated by giving lower weights to the time-specific stay time in decreasing order from a most recently collected time-specific stay time to an older time-specific stay time.

The actual stay time at the POI m may be defined as the sum of a minimum stay time STₘᵢₙ and a congested stay time STⱼₐₘ as shown in FIG. 7. Congestion based on an actual stay time may be defined as shown in Expression 2, for example, based on the minimum stay time. Specifically, when the actual stay time is shorter than 110% of the minimum stay time, congestion may be defined as a smooth state. When the actual stay time is equal to or longer than 110% of the minimum stay time and shorter than 120%, congestion may be defined as a moderate state. When the actual stay time is longer than 120% of the minimum stay time, congestion may be defined as a congested state. Congestion is not limited to the foregoing example and may be generated in various ways. Congestion may be generated as a vector suitable for an output of the neural network illustrated in FIG. 5.

$$\begin{matrix}{ST}_{min} \leq ST < 1.1 {ST}_{min} & smooth \\ 1.1 {ST}_{min} \leq ST < 1.2 {ST}_{min} & moderate \\ ST \geq 1.2 {ST}_{min} & congested\end{matrix} \qquad [ Expression 2 ]$$

The server 200 may train the estimation model using the training demand data and the actual congestion. In the estimation model illustrated in FIG. 5, trainable parameters, that is, weights, constituting the neural network model are trained, and the model may be trained until a loss function between estimated congestion and actual congestion has a certain value or less or a variation in the value of the loss function converges within a certain range.

When the estimation model is trained as described above, the server 200 can estimate congestion of the POI related to the request of the vehicle 100 using the estimation model. A congestion estimation process of the server 200 equipped with the above-described processor 206 will be described in detail below with reference to FIGS. 1 to 8.

FIG. 8 is a flowchart of a congestion estimation method based on route demand according to another embodiment of the present disclosure.

In the present disclosure, an electronic device that requests route guidance and congestion estimation is illustrated as the vehicle 100, and an electronic apparatus that processes the request is illustrated as the server 200. However, the present disclosure is substantially applicable to an embodiment in which the electronic device is a user's portable terminal. Also, unless technically contradictory, an embodiment of the present disclosure is applicable to an embodiment in which the estimation model embedded in the server 200 is transmitted to the vehicle 100 or a user's portable terminal and used by the vehicle 100 or the portable terminal to estimate congestion of a POI. Meanwhile, for convenience of description, the processor 206 and the controller 118 may be interchangeably used with the server 200 and the vehicle 100, respectively.

First, a user may request a search related to a POI through the navigation unit 108 of the vehicle 100 (S105).

The search related to a POI may be, for example, searching for a specified place as the POI when the user inputs a specific name or searching for a place related to a rough term as the POI with an input of the term. Since the search related to a POI is substantially the same as described above in FIG. 1, detailed description thereof will be omitted here. The search may include not only route guidance to a POI in accordance with a user request but also providing additional data related to the congestion of at least one found POI.

The server 200 may acquire demand data based on vehicles that are expected to be traveling in real time along routes detected for the POI related to the user request (S110).

As illustrated in FIG. 4, the processor 206 of the server 200 may acquire demand data of other vehicles related to the user's POI of which the search is requested. The processor 206 may generate demand data using traffic data transmitted by other vehicles or build demand data using traffic data received from an external device, for example, an external traffic management server.

The vehicles that are expected to be traveling along the detected routes may be vehicles that travel along at least portion of the routes after other users of the vehicles request a route to the POI. The other vehicles that are expected to be traveling may be vehicles that request route guidance to the POI through a navigation and travel along at least a part of a guidance route rather than vehicles that are simply traveling to the POI. Details thereof have been described above in FIGS. 1 to 6 and thus will be omitted here.

As illustrated in FIG. 6, demand data may be generated based on the number of vehicles that are expected to be traveling to a road segment on a route for entering the POI at a specified time determined based on the user's expected arrival time at the POI. Here, the demand data may be generated based on operations of a plurality of vehicles for each POI. The specified time may be set to, for example, N minutes after the start time of FIG. 6 corresponding to the user's request time. Also, the road segment on the route for entering the POI may be a road link that is adjacent to the POI and connected to the POI, and the routes detected in at least some of a plurality of other vehicles may include the road link connected to the POI in common. This has been described in detail above in FIGS. 4 to 6, and thus detailed description thereof will be omitted here.

The processor 206 may estimate congestion of the POI based on the demand data using the estimation mode (S115).

The estimation model may be a rule-based mathematical model or a machine-learning-based model. When the estimation model is a machine-learning-based model, the estimation model may be, but is not limited to, a deep learning model employing a neural network model as illustrated in FIG. 5.

The congestion may be generated based on estimated stay time of vehicles at the POI as illustrated in FIG. 7, and may be generated in the form of a congestion level as shown in Expression 2 in accordance with a method based on the minimum stay time. This has been described in detail above in FIGS. 1 to 7 and thus will be omitted here.

The processor 206 of the server 200 may provide the congestion of the POI and a POI list based on congestion to the navigation unit 108 of the vehicle 100 or recommend a POI to the navigation unit 108 based on congestion (S120).

For example, when the user request is input as a specific name to search for a specified place as a POI, the processor 206 may transmit the congestion of the specified specific POI and a route to the POI to the vehicle 100.

As another example, the processor 206 may determine other POIs similar to a specific POI based on additional information, list of other POIs and transmit the POIs to the vehicle, and provide the congestion of the POIs to the vehicle 100. The additional information may include at least one of user information including the POI in accordance with the user request and the user's allowed stay time, map information including the locations of other POIs within a certain range from the POI, or rating information having ratings for use of POIs. The additional information has been described in detail above in FIG. 3 and thus will be omitted here. The congestion of the other POIs may be estimated through the same process as steps S110 to S115.

As still another example, the processor 206 may recommend at least one of the specific POI or other POIs to the user of the vehicle 100 based on congestion and additional information. The congestion of the other POIs may be estimated through the same process as steps S110 to S115.

As yet another example, when a user request is input as a rough term to search for a POI, the processor 206 may transmit a list including at least one POI and congestion thereof to the vehicle 100. Since a plurality of POIs may be found in accordance with the rough term, congestion may be estimated in advance in steps S110 to S115. In addition to this, the processor 206 may select at least one recommended POI among POIs in the list based on the congestion and additional information and provide the selected POI to the vehicle 100.

According to the present disclosure, it is possible to provide a congestion estimation method and device based on route demand that improve the accuracy of congestion information by providing a real-time congestion status of a POI in accordance with a situation of a user who is searching for the POI. In addition, it is possible to increase the reliability of various application functions that are implemented based on accurate congestion information and include recommendation of POIs.

While the exemplary methods of the present disclosure described above are represented as a series of operations for clarity of description, it is not intended to limit the order in which the steps are performed, and the steps may be performed simultaneously or in different order as necessary. In order to implement the method according to the present disclosure, the described steps may further include other steps, may include remaining steps except for some of the steps, or may include other additional steps except for some of the steps.

The various embodiments of the present disclosure are not a list of all possible combinations and are intended to describe representative aspects of the present disclosure, and the matters described in the various embodiments may be applied independently or in combination of two or more.

In addition, various embodiments of the present disclosure may be implemented in hardware, firmware, software, or a combination thereof. In the case of implementing the present disclosure by hardware, the present disclosure can be implemented with application specific integrated circuits (ASICs), Digital signal processors (DSPs), digital signal processing devices (DSPDs), programmable logic devices (PLDs), field programmable gate arrays (FPGAs), general processors, controllers, microcontrollers, microprocessors, etc.

The scope of the disclosure includes software or machine-executable commands (e.g., an operating system, an application, firmware, a program, etc.) for enabling operations according to the methods of various embodiments to be executed on an apparatus or a computer, a non-transitory computer-readable medium having such software or commands stored thereon and executable on the apparatus or the computer.

What is claimed is:

1. A method of estimating congestion based on route demand, the method comprising:
providing an electronic apparatus including at least a memory and a processor;
acquiring, by the processor, demand data based on vehicles that are expected to be traveling to a point of interest (POI) related to a user request;
estimating, by the processor utilizing an estimation model stored in the memory, congestion of the POI based on the demand data; and
providing, by the processor, the congestion of the POI to an electronic device of a user.

2. The method of claim 1, wherein the vehicles are expected to be traveling in real time along at least portion of routes to the POI.

3. The method of claim 1, wherein the demand data is generated based on a number of vehicle that are expected to be traveling to a road segment on a route of the vehicle for entering the POI at a specified time determined based on the user's expected arrival time at the POI.

4. The method of claim 3, wherein the demand data is generated based on a plurality of other vehicles,
the road segment on the routes for entering the POI is a road link that is adjacent to the POI and connected to the POI, and
the route of the vehicle detected in at least portion of the plurality of other vehicles include commonly the road link connected to the POI.

5. The method of claim 1, wherein the congestion is generated based on expected stay time of the vehicles at the POI.

6. The method of claim 1, wherein the estimation model is implemented as a deep learning model,
the estimation model is constructed through training using actual congestion based on actual stay time of vehicles at the POI and training demand data corresponding to the actual congestion, and
the training demand data is acquired based on vehicles that search for a route to the POI and travel along at least portion of the route.

7. The method of claim 6, wherein the actual stay time are determined based on times when arrival of the vehicle at the POI is confirmed and times when departure of the vehicle from the POI is confirmed.

8. The method of claim 6, wherein the actual congestion is generated based on an average of actual stay time accumulated for each of time periods at the POI, and
the average of the actual stay time is calculated as an average of the accumulated actual stay time corresponding to the time periods.

9. The method of claim 1, wherein the providing of the congestion of the POI further comprises providing other POIs and congestion of the other POIs together with the POI, the other POIs being determined to be similar to the POI based on additional information, or recommending at least one of a plurality of POIs based on the congestion and the additional information.

10. The method of claim 9, wherein the additional information includes at least one of user information including the POI in accordance with the user request and the user's allowed stay time, map information including locations of other POIs within a certain range from the POI, or rating information having ratings for use of POIs.

11. An electronic apparatus for estimating congestion based on route demand, the electronic apparatus comprising:
a communication unit configured to transmit and receive data to and from an external device;
a memory configured to store at least one instruction; and
a processor configured to execute the at least one instruction stored in the memory, wherein the processor is configured to:
acquire demand data based on vehicles that are expected to be traveling to a point of interest (POI) related to a user request,
estimate congestion of the POI based on the demand data using an estimation model stored in the memory, and
provide the congestion of the POI to an electronic device of a user.

12. The electronic apparatus of claim 11, wherein the vehicles are expected to be traveling in real time along at least portion of routes to the POI.

13. The electronic apparatus of claim 11, wherein the demand data is generated based on a number of vehicles that are expected to be traveling to a road segment on a route of the vehicle for entering the POI at a specified time determined based on the user's expected arrival time at the POI.

14. The electronic apparatus of claim 13, wherein the demand data is generated based on a plurality of other vehicles,
the road segment on the routes for entering the POI is a road link that is adjacent to the POI and connected to the POI, and
the route of the vehicle detected in at least portion of the plurality of other vehicles include commonly the road link connected to the POI.

15. The electronic apparatus of claim 11, wherein the congestion is generated based on expected stay time of the vehicles at the POI.

16. The electronic apparatus of claim 11, wherein the estimation model is implemented as a deep learning model,
the estimation model is constructed through training using actual congestion based on actual stay time of vehicles at the POI and training demand data corresponding to the actual congestion, and
the training demand data is acquired based on vehicles that search for a route to the POI and travel along at least portion of the route.

17. The electronic apparatus of claim 16, wherein the actual stay time are determined based on times when arrival of the vehicle at the POI is confirmed and times when departure of the vehicle from the POI is confirmed.

18. The electronic apparatus of claim 16, wherein the actual congestion is generated based on an average of actual stay time accumulated during each of time periods at the POI, and
the average of the actual stay time is calculated as an average of the accumulated actual stay time corresponding to the time periods

19. The electronic apparatus of claim 11, wherein the processor is further configured to provide other POIs and congestion of the other POIs together with the POI, the other POIs being determined to be similar to the POI based on additional information, or recommend at least one of a plurality of POIs based on the congestion and the additional information.

20. A non-transitory computer readable medium containing program instructions executed by a processor, the computer readable medium comprising:
program instructions that acquire demand data based on vehicles that are expected to be traveling to a point of interest (POI) related to a user request;
program instructions that utilize an estimation model to estimate congestion of the POI based on the demand data; and
program instructions that provide the congestion of the POI to an electronic device of a user.
